(19) United States
(12) Patent Application Publication
(10) Pub. No.: US 2015/0354755 A1
(43) Pub. Date: Dec. 10, 2015

(54) TANK FOR STORING A GAS STORED BY SORPTION COMPRISING SHOCK-ABSORBING MEANS

(71) Applicants: Dominique MADOUX, Rumes (BE); Jules-Joseph VAN SCHAFTINGEN, Wavre (BE); François DOUGNIER, Boortmeerbeek (BE); Inergy Automotive Systems Research (Societe Anonyme), Brussels (BE)

(72) Inventors: Dominique MADOUX, Rumes (BE); Jules-Joseph VAN SCHAFTINGEN, Wavre (BE); Francois DOUGNIER, Boortmeerbeek (BE)

(73) Assignee: Inergy Automotive Systems Research (Societe Anonyme), Brussels (BE)

(21) Appl. No.: 14/654,338

(22) PCT Filed: Dec. 20, 2013
(86) PCT No.: PCT/FR2013/053213

§ 371 Date: Jun. 19, 2015

(30) Foreign Application Priority Data
Dec. 21, 2012 (FR) 1262723

(51) Int. Cl. F17C 11/00; F17C 1/02

(52) U.S. Cl. CPC F17C 11/005; F17C 1/02; F17C 2203/011; F17C 2205/01; F17C 2221/012; F17C 2260/044; F17C 2203/0636

(57) ABSTRACT

A tank for storing a gas, the gas being stored by sorption to a compound. The tank includes a receptacle configured to contain the compound. The receptacle includes a shock-absorbing mechanism.

### FIELD OF THE INVENTION

The invention relates to a tank for storing a gas.

More specifically, the invention relates to a tank that can be used in a pollution-control or energy-storage system mounted on board a motor vehicle.

The invention is notably, although not exclusively, applicable to the storage of ammonia or of hydrogen. More generally, the invention applies to any type of gas that can be stored by sorption onto a compound.

### BACKGROUND

The rest of this document is devoted to describing the particular case of a tank for the storage of ammonia. The ammonia is, for example, intended to be injected into the exhaust line of a vehicle in order to reduce the amount of nitrogen oxides (NOx) in the exhaust gases. Of course, the present invention applies to any other type of gas, and notably to hydrogen.

The nitrogen oxides present in the exhaust gases of vehicles, notably diesel vehicles, can be removed by the technique of selective catalytic reduction (known by its abbreviation SCR). With this technique, doses of ammonia (NH3) or ammonia precursors are injected into the exhaust line upstream of a catalytic converter on which the reduction reactions take place. At the present time, the ammonia is produced by thermal breakdown of a precursor, generally an aqueous urea solution. On-board systems for storing, dispensing and metering a standardized solution of urea (such as the solution marketed under the trade name Adblue®, which is a eutectic solution of 32.5% urea in water) have thus been marketed.

Another technique is to store the ammonia by sorption onto a salt, usually an alkaline-earth metal chloride. In this case, the storage system generally comprises a tank comprising one or more cells designed to contain the salt.

A “cell” is intended to mean a chamber or cavity delimiting at least one internal volume serving to contain the salt.

The storage system also comprises a heating device configured to heat the salt contained in each cell. Thus, the ammonia is released by warming the salt.

Several types of tank for storing ammonia (or equally hydrogen) by sorption are known. These known tanks generally use single-material, two-material, multi-material or composite cells.

In general, it is desirable for these cells to have low permeability to ammonia (or equally to hydrogen), excellent ability to withstand pressure and good impact resistance.

There is increasing effort to reduce the weight of the tank. One solution might be to reduce the thickness of the cells. However, by decreasing the thickness of these cells the impact resistance of the tank is reduced.

### Objects of the Invention

It is therefore desirable to provide a lightweight tank that also has low permeability, good ability to withstand pressure and good impact resistance.

It is also desirable to provide such a tank that is easy to manufacture, and can be manufactured at low cost.

It is also desirable to provide such a tank which is notably well suited to the storage of ammonia or of hydrogen by sorption.

### SUMMARY OF THE INVENTION

One particular embodiment of the invention proposes a tank for storing a gas, the gas being stored by sorption onto a compound, the tank comprising at least one cell able to contain the compound. Said at least one cell is such that it comprises shock-absorbing means.

The cells of the invention are notably well suited to storing a compound (also referred to as a reactive matrix), preferably a solid, on which a gas (ammonia, hydrogen, etc.) is fixed by sorption, preferably by chemisorption. In the case of ammonia, this is generally an alkali, alkaline-earth or transition metal chloride. It may be in the pulverulent state or in the form of agglomerates. This compound is preferably an alkaline-earth metal chloride and the especial preference is for a chloride of Mg, Ba or Sr. In the case of hydrogen, this compound may for example be boron (B, a metalloid), combined with other elements such as magnesium (Mg), lithium (Li), sodium (Na) or even aluminum (Al). Combinations with potassium (K), nickel (Ni) or chlorine (Cl) may also be suitable.

For example, the cells of the invention may be single-material, two-material, multi-material or composite cells made of metal, plastic or a combination.

In one preferred embodiment, the cells of the invention are made of a single material (for example of plastic). Thus, the idea is to equip a cell with shock-absorbing means so as to be able to reduce the thickness of the cell while at the same time guaranteeing good impact resistance. In other words, the shock-absorbing means according to the invention are able to compensate for the loss of impact resistance caused by reducing the thickness of the cell. Specifically, the shock-absorbing means are dimensioned and mounted on and/or in the cell so as to give it a protective and effective shock-absorbing interface, notably in the event of the tank being involved in an impact or a collision.

By equipping the cells with shock-absorbing means, the thickness of these cells can be reduced. For example, the tank of the invention may comprise composite cells (made for example of glass fiber-reinforced polyphthalamide. For preference, and as will be seen later on in the description, the shock-absorbing means are made from a lightweight material. Thus, the tank of the invention enjoys not only the advantages of a conventional tank (chemical compatability, low permeability and good ability to withstand pressure) but is also lighter in weight (because of the reduction in the thickness of its cell or cells).

The shock-absorbing means according to the invention may, for example, absorb impact energy by elastic or even plastic deformation.

The shock-absorbing means may have any form.

In one particular embodiment, the shock-absorbing means may be two-dimensional auxetic structures, such as, for example, triangular structures, trapezoidal structures or sinusoidal structures. In this embodiment, the two-dimensional structures (forming the shock-absorbing means) may, for example, be distributed at various points on the external surface of the cell. The layout for where to position these two-dimensional structures may, for example, be determined by simulation.

In another particular embodiment, the shock-absorbing means may be three-dimensional auxetic structures, for example a two-dimensional structure wound on a cylindrical surface. Moreover, the auxetic structures may or may not be continuous (have holes).

Auxetic structures are well known. Such structures are described, for example, in the following documents: Choi, J. B. and Lakes, R. S., “Nonlinear properties of polymer cellular materials with a negative Poisson's ratio”, J. Materials Science, 27, 4678-4684 (1992); Choi, J. B. and Lakes, R. S., “Nonlinear analysis of the Poisson's ratio of negative Poisson's ratio foams”, J. Composite Materials, 29, (1), 113-128, (1995); Dong. L, and Lakes, R. S., “Frequency dependence of Poisson's ratio of viscoelastic elastomer foam”, Cellular Polymers, 30, 277-285, (2011); Greaves, G. N., Greer, A. L., Lakes, R. S., and Rouxel T., “Poisson's Ratio and Modern Materials”, Nature Materials, 10, 823-837 November (2011).

In another particular embodiment, the shock-absorbing means may take the form of a protective outer (or layer). The protective outer (that forms the shock-absorbing means) may be configured to cover all or part of the cell. The shape and size of the protective outer are preferably designed to conform to the external surface of the cell. In one particular embodiment, the protective outer may take the form of an elastic case (sock, shell or cover) into which the cell or cells is or are inserted.

Advantageously, the shock-absorbing means are made of a plastic. Thermoplastic polymers give good results in the context of the invention, notably because of the advantages of weight, mechanical strength and chemical resistance, and ease of working (which allows complex shapes to be obtained).

In particular, thermosetting, thermoplastic or elastomeric materials may be used.

In the thermoplastics category, polyethylene and polypropylene are particularly advantageous.

These plastic shock-absorbing means may adhere (mechanically or chemically for example) to the structure of the cell or may not adhere thereto. Adhesion makes it possible to increase impact resistance still further while ensuring that the assembly is better sealed.

Excellent results have been obtained with polyethylene. For example, a protective outer made of polyethylene with a thickness of around 2 mm to 6 mm is entirely suitable for a single-material cell (for example of the type made of metal) approximately 0.2 mm to 0.5 mm thick.

In another particular embodiment, use may be made of a material in the form of a gel and made of silicone.

In yet another particular embodiment, the shock-absorbing means may be made at least in part from a polyurethane foam.

In yet another particular embodiment, the shock-absorbing means may be based on an aluminum foam.

For preference, the shock-absorbing means are mounted on the cell by overmolding. Manufacturing the tank of the invention by overmolding is particularly advantageous because it is simple and economical. Overmolding allows the shock-absorbing means to be assembled in a completely sealed manner on the external periphery of the cell. Moreover, a group of cells can be equipped with shock-absorbing means using just one single same overmolding operation.

Alternatively, it is also possible to plan an adhering polymer layer made of a polyolefin that has been functionalized in order to render it polar and thus cause it to adhere to the cell.

In one particular embodiment, recourse may be had to a layer of polyethylene or polypropylene functionalized by polar functional groups such as acrylates and maleic anhydride. By way of example, recourse may be had to a layer of polypropylene or HDPE grafted with maleic anhydride, such as PRIEX marketed by the Addcomp company.

Of course, other assembly techniques may be employed such as, for example, techniques of clipping, screwing, adhesive bonding, etc.

Advantageously, the shape of the shock-absorbing means and/or the way in which they are embodied and/or assembled is such that they can be used as supports for components.

The tank of the invention can be employed in a pollution-control or energy-storage system mounted on board a motor vehicle. In general, such a system comprises active components and/or hydraulic components, such as, for example, a manifold (a collection of ducts used to direct fluids to determined points).

In one advantageous embodiment, the manifold may be housed (or formed) in the shock-absorbing means.

In another advantageous embodiment, the tank of the invention comprises a set of cells and a network of ducts interconnecting them. This network of ducts may be housed (or formed) in the shock-absorbing means.

Reinforcements in the form of ribs or inserts may be added in order to improve the ability of the cells to withstand pressure and the mechanical strength thereof. Advantageously, such reinforcements are molded into the shock-absorbing means.

For example, glass fiber or carbon fiber fabric or metal mesh may be housed within the shock-absorbing means.

In one advantageous embodiment, the tank of the invention comprises one or more heating element(s) and/or phase change materials (PCMs). In particular, use may be made of heating wires, thermistors of the PTC (positive temperature coefficient) type or flexible heaters known for heating the compound contained in each cell.

The use of heating (and/or cooling) elements or of phase change materials means that the temperature of the reagent contained in the cell can be stabilized thus ensuring a stable production of ammonia. In addition, the use of heating which is differentiated between cells and/or of phase change materials in relative quantities that differ between cells means that certain cells can be rendered less or more rich in ammonia; for example during a system shut down (following for example a stoppage of the vehicle), the ammonia charge in the cells cooling more quickly (for example containing little or no phase change material) will increase at the expense of the cells cooling more slowly (containing for example a great deal of phase change material). This may be particularly beneficial in ensuring that ammonia becomes quickly available after a vehicle stoppage, for example by preferentially activating the ammonia-rich cells at this time.

For example, the heating element or elements may be placed outside the cell.

By overmolding a protective layer of plastic (forming the shock-absorbing means) over the cell, the protective layer presses the heating elements against the cell and holds them firmly (after shrinkage). Thus, this assembly allows for permanent contact between the heating elements and the cell, and therefore makes it possible to improve the exchange of heat between the heating elements and the compound stored in the cell. The protective layer made of plastic (forming the shock-absorbing means) also provides the cell and the heating elements with thermal insulation from the outside.

Advantageously, the shock-absorbing means comprise securing means allowing the tank of the invention to be mounted on the vehicle.

The securing means may have any form.

In one particular embodiment, the shock-absorbing means comprise surplus plastic forming securing lugs. These securing lugs can be configured to engage in housings formed on the vehicle then assembled by any known means, such as clamping for example.

In one particular embodiment, the shock-absorbing means comprise surpluses of plastic forming securing lugs. These securing lugs are assembled on the vehicle by any known means, such as by screwing, clipping for example.

Advantageously, the cell is made of or comprises at least one metal mesh part. Thanks to these mesh parts, the cell may have sophisticated shapes. This is because the mesh parts can be bent or curved. The shape of the cell can therefore be readily adapted to suit its environment on a vehicle.

This mesh may be obtained by cutting or piercing continuous metallic structures. The holes thus obtained may allow these metallic structures to be assembled prior to overmolding.

The mesh parts may also be obtained by any other means, for example by criss-crossing wires. These elements may also be pre-assembled before overmolding, or not.

By overmolding a protective layer of plastic (forming the shock-absorbing means) over the cell, the plastic advantageously penetrates the mesh parts in order to render it sealed. This assembly therefore makes it possible to ensure both an ability to withstand pressure, sealing, and shock absorption.

In one particular embodiment, almost all, or even all, of the cell may be made of metal and/or plastic mesh. This means that the weight of the cell and therefore of the tank can be reduced still further.

### LIST OF FIGURES

Further features and advantages of the invention will become apparent from reading the following description, given by way of non-limiting indication, and from studying the attached drawings in which:

FIG. 1 schematically illustrates a tank according to a first particular embodiment of the invention;

FIG. 2 schematically illustrates a tank according to a second particular embodiment of the invention;

FIG. 3 schematically illustrates a tank according to a third particular embodiment of the invention;

FIG. 4 schematically illustrates a tank according to a fourth particular embodiment of the invention;

FIG. 5 schematically illustrates a tank according to a fifth particular embodiment of the invention;

FIG. 6 schematically illustrates a tank according to a sixth particular embodiment of the invention;

FIG. 7 schematically illustrates a tank according to a seventh particular embodiment of the invention; and

FIG. 8 schematically illustrates a tank according to an eighth particular embodiment of the invention.

### DETAILED DESCRIPTION

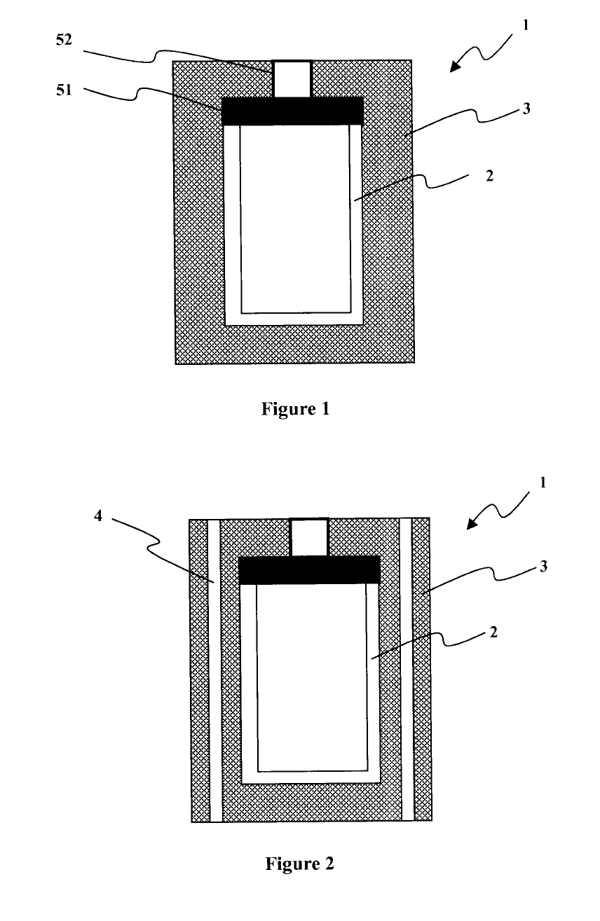

In FIGS. 1 to 8, identical numbers denote identical elements.

Exemplary embodiments in which the gas stored by sorption onto the compound is ammonia are described hereinbelow in conjunction with FIGS. 1 to 8. Of course, in an alternative form of the embodiment the gas may be of any other type, notably hydrogen. Furthermore, exemplary embodiments in which the tank comprises one cell which may be made of composite (for example glass fiber-reinforced polyphthalamide), of metal or of single-layer or multi-layer plastic are described in conjunction with FIGS. 1 to 8. Of course, in an alternative form of embodiment the cell may be made of any other type of material.

FIG. 1 schematically illustrates a tank according to a first particular embodiment of the invention.

The tank 1 comprises a cell 2. In the example illustrated, the cell 2 is of cylindrical shape. This cylindrical shape is obtained, for example, using a method of pressing, stamping or hot or cold forging. In one alternative form of embodiment this cylindrical shape is obtained by a hot pressing or cold extrusion method. Of course, in another embodiment, the cell 2 may have a different shape.

A lid 51 of any shape is fixed over the cell 2. The lid 51 is assembled with the cell 2 in a sealed manner. For example, in the particular case of a metal cell, assembly between the lid and the cell may notably but not exclusively be achieved by arc welding, laser welding, TIG (Tungsten Inert Gas) or MIG (Metal Inert Gas) welding.

Advantageously the lid has at least one orifice 52 allowing filling with ammonia, for example from a cylinder for example. In one particular embodiment, the lid may comprise safety elements, ventilation elements, measuring elements or even reinforcing elements. For example, the lid 51 may comprise a safety valve, a pressure sensor and a filter. Thus it is possible to obtain a tank that is compact and smart (which means to say that it has integrated functions, integrated for example into the lid).

The cell 2 is dimensioned so that a compound (not depicted) can be introduced into said cell and stored in it. The compound is, for example, a solid (preferably a salt). The ammonia is stored by sorption onto the compound. When the compound is heated, ammonia is released. The ammonia thus released leaves the cell via, for example, the orifice 52.

The tank 1 comprises a protective layer 3 of plastic (for example) which is overmolded on top of the cell 2. The protective layer 3 forms shock-absorbing means making it possible to absorb the kinetic energy of a shock. It is the plastic deformation of the protective layer 3 that absorbs the energy of the shock.

Thanks to the presence of this protective layer 3, the thickness of the wall of the cell 2 can be relatively small. In the particular case of a metal cell, the thickness of the cell may be around 0.4 mm and the thickness of the protective layer 3 may be around 2 mm.

FIG. 2 illustrates an alternative form of embodiment of the tank 1 described hereinabove in conjunction with FIG. 1. In this alternative form the protective layer comprises the reinforcing elements 4. For example, fiber glass inserts yield good results. In the example of FIG. 2, the reinforcing elements 4 are molded into the protective layer 3. The use of these reinforcing elements 4 advantageously allows the impact resistance of the tank and its ability to withstand pressure to be increased.

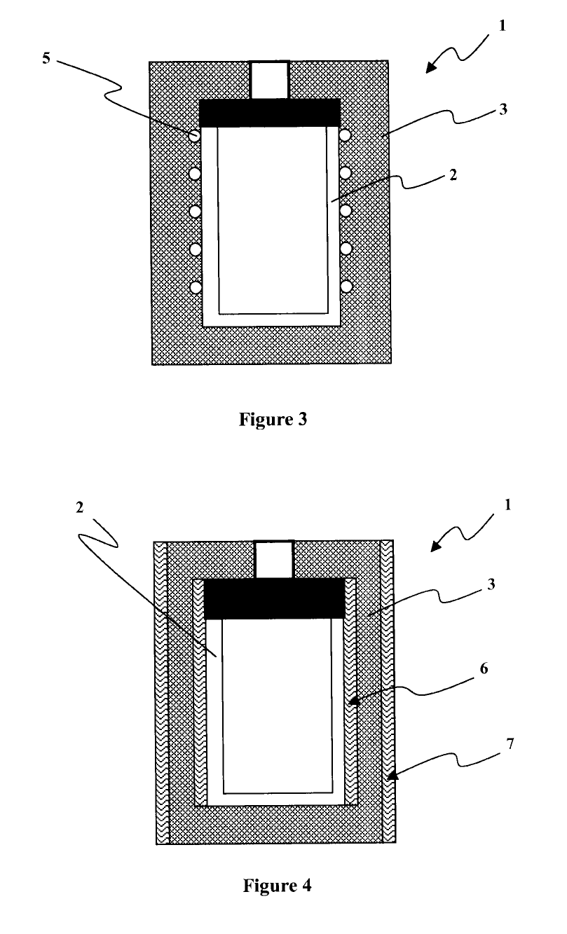

FIG. 3 illustrates an alternative form of embodiment of the tank 1 described hereinabove in conjunction with FIG. 1. In this alternative form, the tank 1 comprises a heating element 5 such as, for example, heating wires or a flexible heater. The heating element 5 is controlled (activated/deactivated) by a command and control unit on board the vehicle (for example the vehicle ECU) to heat the compound contained in the cell 2. In one embodiment, the tank 1 may be assembled as follows: the heating element 5 is wound around the external wall of the cell 2, then the protective layer 3 is overmolded on top of that assembly. In that way, the protective layer 3 allows the heating element 5 to be kept in contact with the cell 2. The protective layer 3 also provides the cell 2 and the heating element 5 with thermal insulation from the outside. Thus, the tank enjoys better heating.

FIG. 4 illustrates an alternative form of embodiment of the tank 1 described hereinabove in conjunction with FIG. 1. In this alternative form, the tank 1 comprises auxetic structures 6 and 7. These auxetic structures 6 and 7 may, for example, be made from a thermoplastic that is identical to or different from that of the protective layer 3. The auxetic structures 6 and 7 allow the impact strength of the tank 1 to be increased.

In one exemplary embodiment, the tank 1 may be assembled in one or more consecutive overmolding operations: a first auxetic structure 6 is overmolded over the cell 2, then an intermediate thermoplastic layer 3 is overmolded, and then a further auxetic structure is possibly overmolded on top of the protective layer 3.

In another exemplary embodiment, the tank 1 may be assembled in a single overmolding step. In other words, the protective layer 3 and the external auxetic structure 7 may be produced in a single hit. Such an assembly is therefore quick and economical.

In yet another exemplary embodiment, the auxetic structures 6 and 7 may be inserted into the protective layer 3.

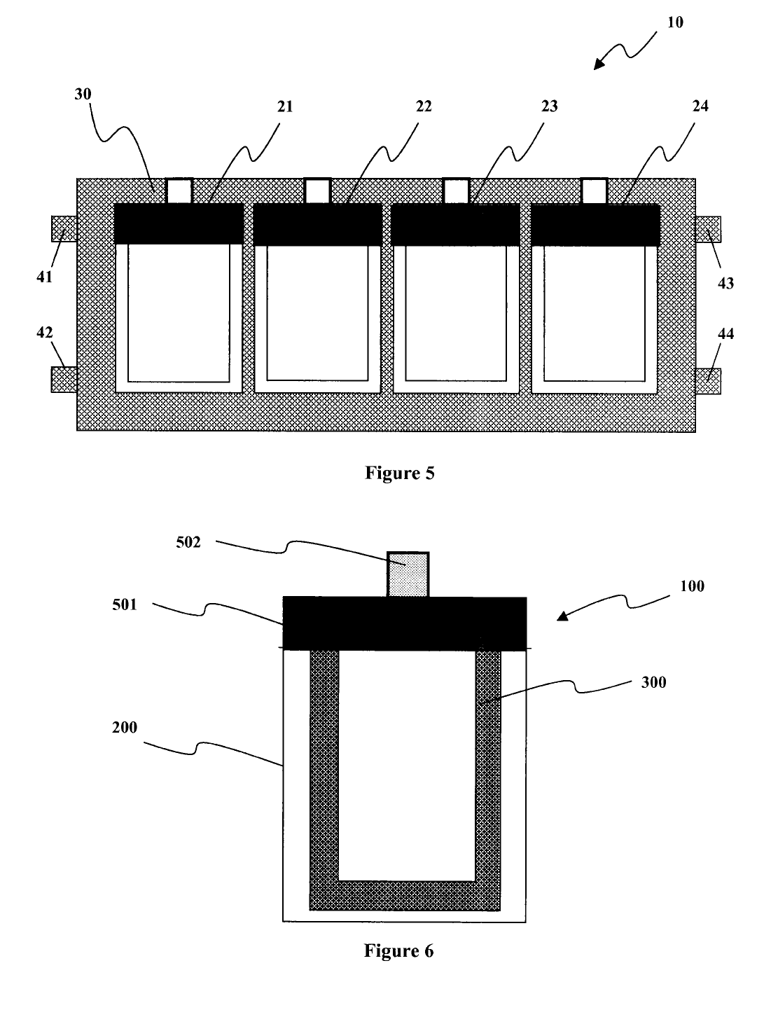

FIG. 5 schematically illustrates a tank according to a fifth particular embodiment of the invention.

The tank 10 comprises a group of cells 21, 22, 23 and 24. For preference, the cells 21, 22, 23 and 24 are identical. Of course, in one particular embodiment they may have different shapes and/or different storage volumes. Each of the cells 21, 22, 23 and 24 contains a compound which by sorption stores ammonia for example. The tank 10 comprises a protective layer 30 of plastic (for example) which is overmolded on top of the group of cells 21, 22, 23 and 24. The protective layer 30 forms shock-absorbing means able to absorb the kinetic energy of a shock. In the example illustrated in FIG. 5, the protective layer 30 comprises securing lugs 41, 42, 43 and 44. For example, these securing lugs 41, 42, 43 and 44 may be formed during the step of overmolding the protective layer 30 over the group of cells. These securing lugs 41, 42, 43 and 44 thus allow the tank 10 to be mounted easily and accurately in the vehicle.

FIG. 6 schematically illustrates a tank according to a sixth particular embodiment of the invention.

The tank 100 comprises a cell 200. A lid 501 of any shape is fixed over the top of the cell 200. The lid 501 has an orifice 502 via which the cell 200 communicates with the outside.

In the example illustrated in FIG. 6, the tank 100 comprises a protective layer 300 of plastic (for example) which is overmolded on the inside of the cell 200.

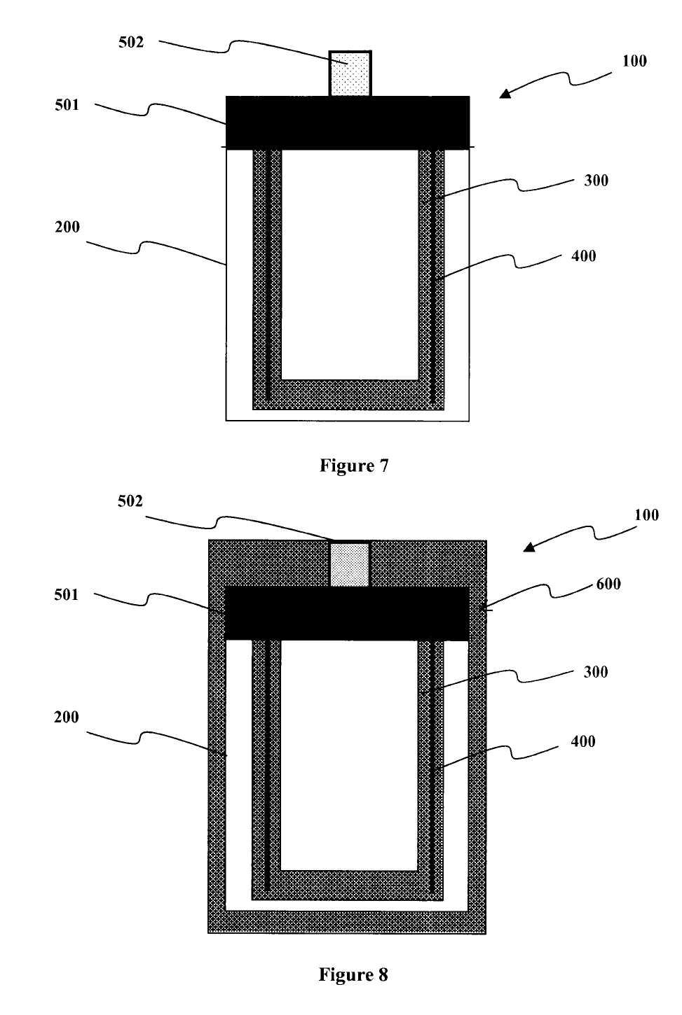

FIG. 7 illustrates an alternative form of embodiment of the tank 100 described hereinabove in conjunction with FIG. 6. In this alternative form, the internal protective layer 300 comprises metal heating elements 400. These metal elements 400 are, for example, assembled by overmolding. Overmolding advantageously makes it possible to provide sealed connections between these metal elements.

FIG. 8 illustrates an alternative form of embodiment of the tank 100 described hereinabove in conjunction with FIG. 7. In this alternative form, the tank 100 comprises an internal protective layer 300 of plastic (for example) which is overmolded on the inside of the cell 200 and an external protective layer 600 of plastic (for example) which is overmolded over the top of the cell 200.

Other alternative forms of embodiment can be conceived of without departing from the scope of the present invention, for example by combining elements of the various embodiments described hereinabove in conjunction with FIGS. 1 to 8.

1-10. (canceled)

11. A tank for storing a gas that is stored by sorption onto a compound, the tank comprising:
at least one cell configured to contain the compound;
wherein the least one cell comprises a shock absorbing means.

12. The tank as claimed in claim 11, wherein the shock absorbing means is at least partially made from a thermoplastic polymer.

13. The tank as claimed in claim 12, wherein the shock absorbing means is made of polyethylene.

14. The tank as claimed in claim 12, wherein the shock absorbing means is made of polypropylene.

15. The tank as claimed in claim 11, wherein the shock absorbing means is overmolded onto the at least one cell.

16. The tank as claimed in claim 11, the tank being included in a pollution control or energy storage system, the pollution control or energy storage system comprising a component, and wherein the shock absorbing means comprises at least part of the component.

17. The tank as claimed in claim 11, further comprising at least one reinforcing element molded into the shock absorbing means.

18. The tank as claimed in claim 11, further comprising at least one heating element, and the shock absorbing means keeps the heating element in contact with the at least one cell.

19. The tank as claimed in claim 11, wherein the shock absorbing means comprises tank securing means.

20. The tank as claimed in claim 11, wherein the at least one cell comprises at least one metallic mesh part.
